(19) United States
(12) Patent Application Publication
(10) Pub. No.: US 2010/0293202 A1
(43) Pub. Date: Nov. 18, 2010

(54) CONTENTS RELATIONSHIP MANAGEMENT SYSTEM BY MULTIPLE INTERNET DOMAIN

(76) Inventors: Ki-Mi Kim, Seoul (KR); Sung-Sig Sim, Seoul (KR)

Correspondence Address: BROOKS KUSHMAN P.C., 1000 TOWN CENTER, TWENTY-SECOND FLOOR, SOUTHFIELD, MI, 48075, US

(21) Appl. No.: 12/681,209

(22) PCT Filed: Oct. 1, 2008
(86) PCT No.: PCT/KR08/05763

§ 371 Date: Jul. 20, 2010

(30) Foreign Application Priority Data
Oct. 1, 2007 (KR) 10 2007 0098879

(51) Int. Cl. G06F 17/30

(52) U.S. Cl. 707/803; 707/E17.005

(57) ABSTRACT

The present invention relates to a multi-relational multi-dimensional Internet data bidirectional website management system using multi-Internet addresses, which can manage a bidirectional website based on a certain relation criterion by formalizing file data of a base home page or constructing the file data as a database.

### TECHNICAL FIELD

The present invention relates to a multi-relational multi-dimensional Internet data bidirectional website management system, more specifically, wherein contents information, product information, service information, cafe board, blog, picture information, and news information, which are created in respective websites, are formalized or created as a database, and a website using one or more separate Internet addresses establishes a relation with bidirectional information through a web program. Since Internet contents related to one another are shared among websites, information in each related website is updated in real-time when Internet contents are updated or added. At the same time, it is also possible in the opposite direction. According to the system, a relation type is determined among one or more different websites, and a plurality of relation criteria, such as a region, business type, contents, personal information, and the like, are assigned within an object relation type, network relation type, unary and extended relation type, hierarchy relation type, and complex relation type of multiple relations. Therefore, it is possible to create an upper and lower structure, horizontal array structure, vertical array structure, parallel structure, series structure, and the like, which are multi-dimensional structure arrays of a complex relation type, and a plurality of websites that can be multi-dimensionally analyzed and compared can be created by the contents, region, and kind from one or more websites, using different multiple Internet addresses. Although a multi-dimensional parallel structure of the network relation type does not have a relation criterion, contents that can be mutually complemented are related among a plurality of websites to share Internet contents, and thus if the contents are updated in one website, the updated contents can be shown in another site at the same time. In a multi-dimensional parallel structure of the unary and extended relation type, a plurality of multi-dimensional websites are created from a website, using a plurality of different Internet addresses. In multi-dimensional vertical and horizontal array structures of the object relation type, one or more websites are considered as objects, and it is possible to create a multi-dimensional website that can show contents of different structures in a plurality of websites based on relation criteria (a business type, region, etc) using various different Internet addresses. In a multi-dimensional upper and lower structure of the hierarchy relation type, a personal website can be constructed using a different Internet address containing a phone number and related customer, related company, subcontracted company, or rResale company can be connected to a website of an enterprise. In such a variety of multi-dimensional arrays, the upper and lower, parallel, series, horizontal array, and vertical array structures can be applied to each other in a complex form. Therefore, it is a search engine technique of a new concept, in which complex Internet data are created as arrays, and contents can be easily compared, analyzed, and searched for through the internet address bar within any type web browser if only simple information such as a phone number or the like is known. Furthermore, although the contents cannot be searched for through the address window, it can be serviced by creating a website that searches for a specific multi-dimensional structure.

### BACKGROUND ART

Recently, a variety of businesses, such as Internet shopping-malls, off-line stores, shopping-malls, enterprises, real estate agencies, car dealers, government offices, advertisement companies, schools, and the like, constructs a large number of websites, shopping-mall sites, and portal sites on the Internet owing to advancement in the Internet. However, each of these websites uploads existing contents on web search sites mainly for searching purpose. Thus, if customers search for the contents through a search engine, the website only allows the customers to visit the websites through displayed search results. The displayed search results merely show information on indexes. Particularly, since there are only a small number of specialty portal sites that can compare and analyze contents, the customers themselves should have spent a plenty of time to search for contents. Due to such a problem, it is the best for a large number of small-scaled shopping-mall stores, such as enterprise websites, particularly, off-line stores and the like, to merely upload their websites on a search engine or their products on a large-scaled Internet shopping-mall to sell the products, or pay advertisement fees to portal site companies where many customers visit and expect the customers themselves to visit their sites. Therefore, sales and techniques of large-scaled portal companies having search engines and large-scaled Internet shopping-mall sites are rapidly soared on the Internet. As a result, there is a phenomenon of the poor becomes the poorer and the wealthy becomes the wealthier of each website, and a phenomenon to be subordinate to enterprises advocating portal search engine websites and integrated shopping-mall websites.

Accordingly, web customers practically using the websites have to additionally pay the cost, such as fees for advertising the search engines and uploading the websites on the large-scaled Internet shopping malls when the customers use each of the websites. Such a phenomenon has a problem in that information on Internet contents, which pursues diversity in the existing web, is fixed to only a few websites. A furthermore serious problem is that since a large number of Internet addresses are already registered, a newly established Internet company purchases existing Internet addresses from an Internet address registration company by paying a lot of money in order to secure Internet addresses or abandons the purchase of the Internet addresses. Therefore, subordination of contents and techniques is further intensified, which acts as a factor that makes advancement in web techniques further slow. In managing contents of each website, until today, there are personnel for inputting contents or companies for managing contents, and the contents should be periodically updated in order to persuade a large number of customers to visit the contents in reality. However, although small-scaled stores or most of enterprises, off-line stores, and the like construct a website, they do not have sufficient time and man power for managing the website to periodically update the contents, and thus the customers frequently turn against the website. Furthermore, customers visit a plurality of fixed large-scaled portal sites where they joined as a member, check mails, deal with spam mails, and view stereotyped information in reality. Since the customers cannot analyze information at once through specialty and diversity by viewing banners or other advertisements connected between portal sites, there is an inconvenience in that the customers should spend time to search for a plurality of connected websites. Particularly, although a large number of large-scaled portal companies advocate web 2.0 and construct an Internet site in concept of web 2.0, they only manage the contents visited through personal accounts registered in one site. Contents connected and constructed by individuals are constructed by frequently participating specific individuals, rather than by all of the individuals, and thus, limited persons participate in web 2.0 depending on the tastes of connecting people in a point of view.

A multi-relational multi-dimensional technique of a new concept is configured in a structure in which customers by themselves construct and consume contents. Therefore, diversity is secured, and the customers may directly participate in marketing of an enterprise for specialized matters owing to bidirectional contents techniques. Rather than a method persuading customers to visit, there needs a right of customers to select one of multi-dimensional channels of Internet contents.

In addition, as various kinds of information communication terminals are manufactured owing to advancement in information communications, it takes a lot of time to connect to the web and search for a website due to the functional nature of a terminal keyboard. In addition, since many websites are created, character type addresses for easily searching for a website are already registered or in shortage. Therefore, a large number of characters are registered as Internet addresses, which results in ignorance of a correct Internet address, and it is difficult for a customer to find an Internet address of a related company. The situation is the same in an e-mail system.

Accordingly, in order to solve the problem, contents of websites could be updated and analyzed through specialty and diversity, and each of the websites should be able to add contents secured through a variety of channels and easily search for the contents if a customer knows related information such as a phone number, address, business type, contents type, or the like, although the customer is ignorant of the web address. Particularly, since information on the existing phone number systems is already stored in computers or information communication terminals and an existing phone number is information that can be easily searched for at any place, a multi-relational multi-dimensional site of a new concept is a technique that converts a phone number system into a website system.

Therefore, using the technique that can easily build one or more websites as a databae or formalized contents and then construct the database or contents into a website having the same copied, shared, or added contents and using a different Internet address, it is possible to insert a phone number or related information into an Internet address and easily find a website. An e-mail address can also be rendered using a phone number of a mobile telecommunication terminal. Furthermore, since each company can build a website having a different Internet address only for customers, the new concept of connecting the website to contents of a website of a mother company and adding and updating its contents provides customers with new channels and provides companies with a technique that can diversely and easily update and manage the contents. Since an object relation type, network relation type, unique and extended relation type, hierarchy relation type, and complex relation type of multiple relations, which put emphasis on the relationship among all websites, are models of cooperating with one another and are connected to increase in sales of a company, a multi-relational multi-dimensional Internet data bidirectional website management system using multi-Internet addresses is needed.

### DISCLOSURE OF INVENTION

### Technical Problem

The present invention is conceived to solve the aforementioned problems. An object of the present invention is to provide a multi-relational multi-dimensional Internet data bidirectional website management system using multi-Internet addresses in order to intensify update, management, specialty, diversity, and marketing of each website where customers can easily visit, wherein a variety of contents of related shopping-malls, off-line stores, enterprises, government offices, advertisement companies, schools, Internet shopping-malls, and the like can be shared and associated with one another in each website, and customers construct their own website using an Internet address such as a phone number different from those of the others and establish a relationship with the contents of the related companies, so that all the customers can easily access the Internet contents of the variety of companies, and all information communication terminals of the customers can associate with and analyze those websites.

### Technical Solution

According to an aspect of the present invention for achieving the object, there is provided a multi-relational multi-dimensional Internet data bidirectional website management system using multi-Internet addresses, which comprises an Internet server 6 provided with a database 4 for storing data; companies 12, 33, and 34 and websites 2, 14, and 26 registered in the Internet server 6; and Internet terminals 8 of companies and customers that can be connected to the Internet server 6 through the Internet, wherein the Internet server 6 partitions a base file of a home page file of a registered website 2 by a type of contents, such as a configuration menu file (profile, product, service, contact us, etc) of an entire display area of each home page, using Internet program (ASP), categorizes the partitions by a different partition name 35 depending on a position, formalizes information such as position information 36, tag information 37, corresponding data information 39, and image information, etc, and the like or constructs the information as a database, allows applying partitioned configuration of the base file depending on a relation type, creates data that can be shared bidirectionally by connecting the website data formalized or constructed as a database, based on a variety of relation criteria, assigns a variety of different Internet addresses thereto, and creates a multi-dimensional bidirectional website 9, 10, 13, 15, 20, and 23 based on a base configuration file table of a new home page.

That is, in the multi-relational multi-dimensional Internet data bidirectional website management system using multi-Internet addresses of the present invention, one or more websites 2, 14, and 26 managed by a company 12,33 and 34 or operator are loaded on one or more Internet servers 6. The entire display area of a base file among the home page file of one or more websites, e.g., the website of a realtor office 12 in Seoul, is divided into a plurality of partitions, and each of the partitions is named as a different partitioned file name 35 by an Internet program (ASP) or the like depending on the position. Then, a lot of information, such as position information 36, tag information 37, corresponding data information 39, image information, and the like, is formalized or constructed as one or more database, and partitioned configuration of the base file is applied by the file 38 of the configuration menu file(profile, product, service, contact us, etc) of each home page. In connection and relation to the partitions, product information 40, service information 41, cafe board 42, blog, picture information, news information, RSS information, multimedia, and the like, which are Internet data displayed among the configuration menu of the site, are formalized or constructed as a database 4.

The website data formalized or constructed as a database, as described above, are connected in a variety of relation types based on a variety of relation criteria in order to generate data that can be bidirectionally shared, and a multi-dimensional website is constructed on the basis of a base configuration file table (FIG. 4) of a home page using various different Internet addresses. First, in the object relation type, each website is connected to an object as shown in FIG. 2, and the websites are arranged in the vertical and horizontal directions in the form of multi-dimensional Internet data based on relation criteria, in order to construct a variety of multi-dimensional websites 9, 10, 20, and 23 for bidirectionally managing the Internet data by the contents type (product information 40, service information 41, cafe board 42, blog, picture information, news information, RSS information, moving, and multimedia, and the like), region, business type, and the like. Second, the network relation type is for constructing multi-dimensional Internet data bidirectional management websites 2, 14, and 26 of a parallel form, i.e., a multi-dimensional Internet data array, in order to enhance the effect of visiting the websites through strategic combination of the contents, rather than a relation criterion. Third, the hierarchical type is for constructing websites 26, 11, and 7 partitioned in a hierarchy based on one or more vertical structure arrays and bidirectionally managed through personal information or other common criterion information of a multi-dimensional structure, in the database 4 of each website storing schools 26 and students 11, companies and customers, and the like. Fourth, since a multi-dimensional website of the unary and extended relation type is a concept for constructing websites using different Internet addresses for the same website, the multi-dimensional array is close to a series structure.

Such a unary and extended relation type is effective in that further more website channels are created and more customers visit an existing website through the channel. For example, the unary relation type includes a multi-dimensional bidirectional website 13 that uses an Internet address quoting a phone number in order to allow customers to visit the website only with an address although a customer is ignorant of the domain of the website and a unary relational multi-dimensional website 13-1 that converts a phone number to a website address through a specific service provider, and there is an extended relational multi-dimensional bidirectional website 15 constructed as a portal website by adding some contents to a website.

A feature of the multi-relational multi-structure bidirectional website is that since a menu file, Internet data, and the like are formalized or constructed as a database by a base file of a home page divided into a plurality partitions, and applied to configure a page, it is easy to design a website and update and manage contents. Relations among all multi-dimensional websites should be basically established, and the websites can be multi-dimensionally compared and analyzed through various kinds of arranged Internet data that are rendered based on a relation criterion. In addition, each of the multi-relational multi-dimensional websites should be bidirectionally shared in order to revitalize communications. Like a unary and extended relational multi-dimensional website, a plurality of channels can be created using Internet addresses including relation criterion information such as phone numbers of related companies. Particularly, each of the websites 2, 14, and 16 automatically inputs and updates the multi-dimensional relation type websites 9, 10, 13, 15, 20, and 23 in real-time by inputting and updating data only once through the database 4 storing the data in a relational form or a formalized system. In the same manner, the same is also possible in the opposite direction, and thus bidirectional input and update are possible in real-time. Another feature is that if there is relational Internet data, various relations are compositely applied, and various other relation criterion conditions can be added to the relations. For example, a plurality of business types 18 divided into object relational multi-dimensional Internet data are arranged in a business type specialty web portal site 10, and data of each region 16 are arranged in a regional specialty web portal site 9. A plurality of contents specialty sites 20 are constructed depending on the type of contents. Particularly, for personal information data such as a phone number, a personal information specialty site 23 allows one or more personal sites of a hierarchy relational multi-dimensional type to bidirectionally share the same criterion information, and thus a plurality of personal websites are constructed. When such an individual exchanges a name card with other people, a multi-dimensional website having a network relation with other personal websites is constructed.

The configuration of the entire system comprises a constructed Internet server 6, companies 12, 33, and 34 and websites 2, 14, and 26 registered in the server, and Internet terminals 8 of the companies and customer that can be connected to the Internet server 6 through the Internet. The registered websites share and partition Internet data of a multi-relational multi-dimension in connection with other websites to formalize the Internet data or constructed the Internet data as a database 4 depending on various relational forms such as contents types, regions, business types and the like, thereby constructing multi-dimensional bidirectional websites 9, 10, 13, 15, 20, and 23.

Next, in the multi-relational multi-dimensional Internet data bidirectional website management system using multiple Internet addresses of the present invention, various Internet address names containing a phone number or the like are formalized by applying a rule to the created multi-dimensional bidirectional website 9, 10, 11, 13, 15, 20, and 23, and the website can be searched for through the internet address bar within any type web browser. That is, in the multi-relational multi-dimensional Internet data bidirectional website management system using multiple Internet addresses of the present invention, various Internet address names containing a phone number and the like are formalized by applying a rule to the created multi-dimensional websites 9, 10, 11, 13, 15, 20, and 23, and the website can be searched for through the internet address bar within any type web browser, in the Internet server 6 and database 4. Particularly, a specific Internet address and a server can be created to provide a service for converting personal information such as a phone number and the like into the Internet address, and a server and a website that can convert a mobile telecommunication terminal number into an e-mail can be constructed. In addition, it is possible to construct a website that is dedicated to convert a contents type, region name, product name, service name, or the like into an Internet address in the internet address bar within any type web browser.

A computer 8 or a mobile telecommunication terminal 22 of a customer connected to the internet stored in related information such as a phone number, mobile telecommunication phone number, and name, and it is possible to connect to a service site that converts the phone number information into various specific Internet addresses and display desired websites. In the same manner, a service for converting the phone number information into an e-mail is provided, and thus a service for transmitting an e-mail can be provided although an e-mail address is unknown. In addition, if special characters or related information conforming to a specific rule is inputted in the internet address bar within any type web browser or inputted and executed in a search system of the site using a specific site that provides Internet address conversion service, all of the information related to the multi-dimensional websites is displayed, and thus the website information can be further correctly and rapidly compared and analyzed in multi-dimension compared with a result obtained through a search engine. Particularly, if related information is used as an address in a specific site or inputted and executed in a search system of the site, related information is displayed as a table or figure designed as an array of a multi-dimensional structure, and thus there is provided a search system of a new concept that allows a customer to know how to find desired information or how to analyze and compare the information with other information. For example, since each of the companies 12, 33, and 34 or the like stores phone numbers or mobile telecommunication phone numbers of customers of all the other companies being in a multiple relation in the database 4 of the websites 2, 14, and 26 that use different Internet addresses, and particularly, there are too many hierarchy relational multi-dimensional websites, i.e., personal websites, it is difficult to distinguish the websites by domain information. Therefore, if hierarchy relational multi-dimensional websites 7 and 11 are constructed using phone numbers or personal information as Internet addresses, phone numbers are stored in the phone book of a computer or a communication terminal 22 connected to the Internet. Therefore, if another customer loads a phone number of a person or inputs simple personal information and presses a special symbol or delimiter, the special delimiter is recognized, and the computer or communication terminal is connected to the Internet through a mobile telecommunication base station 21 and a mobile telecommunication company system 24. Then, using the database 4 of the server 6, personal Internet sites 7 and 11, i.e., corresponding hierarchy relational multi-dimensional websites, are loaded on the communication terminal 22 of the customer through the mobile telecommunication base station 21 and the mobile telecommunication company system 24.

In the same manner, a phone number of a company, restaurant, business place, motel, travel agency, tour-related business place, public service office, government office, or the like stored in the computer or communication terminal 22 is considered important, and a business place is constructed as a unary relational multi-dimensional website having a phone number as an Internet address. Then, if a phone number is inputted in a field for inputting an Internet address, websites 2, 14, and 26 of corresponding companies are automatically displayed. For example, as shown in FIG. 1, if the phone number of a B car sale office 33 in Daejeon, which is stored in the database 4 of the web server 6, is 0417771234, in addition to the address www.b.com of the website of the B car sales office in Daejeon, a website that is the same as the website of the B car sales office having an Internet address of www.7771234.com is created using the phone number by the unary relational multi-dimensional Internet data bidirectional website management system. Particularly, another Internet address containing a phone number is created using a specialized unary relational multi-dimensional website system, and the address and phone number of a specific website (e.g., www.phone2web.com) that is specialized to provide a service for associating a phone number and an Internet address are combined regardless of the method of combination (e.g., www.phone2web.com/7771234 or 7771234.phone2web.com).

Therefore, an Internet address can be easily searched for only if the phone number is known. This is possible due to a self series structure among unary relational multi-dimensional arrays, i.e., a multi-dimensional website that creates websites 13 and 15 that are the same as the original website 14 through the database 4 of the web server 6. A mobile telecommunication company can recognize the symbol or delimiter, which is possible if a server of each mobile telecommunication company system 24 only converts a value of the symbol or delimiter into the address of a website of a company (e.g., www.phone2web.com) that is specialized to provide a service for associating a phone number with an Internet address and uses a different Internet address. Since a lot of people know the phone numbers of the websites 2, 14, and 26 although the Internet addresses thereof are unknown, a correct website address can be searched for if only the phone number is known.

Particularly, an e-mail address such as 0112223333@7771234.com is created using a phone number or a mobile telecommunication terminal number in the same manner. That is, an account of SMTP and POP3 servers of the unary relational multi-dimensional website (e.g., www.7771234.com) is created in the server 6, and an e-mail can be transmitted and received through the account. In this method, if a customer knows the mobile telecommunication number of a person to whom the customer desires to send an e-mail from the phone book of the mobile telecommunication terminal 22 connected to the Internet, and inputs a special character, a delimiter, and the mobile telecommunication terminal number of a customer who receives the e-mail without an order, the special character and the delimiter are distinguished through the server 24 of the mobile telecommunication company, and a general phone number (e.g., 7771234) is searched for from the database 4 of the server 6 using the mobile telecommunication phone number (e.g., 0112223333).

Then, the account of the mobile telecommunication phone number (e.g., 0112223333) is searched for from the SMPT and POP3 servers having a unary relational multi-dimensional website of the general phone number (e.g., www.7771234.com) as an address, and an e-mail is transmitted. As another method, if a website (e.g., www.phone2web.com) that is specialized to convert a phone number to an Internet address as described above is connected to a mobile telecommunication terminal and an e-mail is transmitted to the e-mail address (e.g., 0112223333@phone2web.com), a counterpart's e-mail address or general phone number is correctly searched for from the database 4 of the server 6 that stores an extended relational multi-dimensional website (e.g., www.phone2web.com) of the website of the B car dealer in Daejeon 14, and the e-mail is delivered, for example, to the e-mail address (0112223333@7771234.com). Extending furthermore, if a subject word common to the contents is inputted in the Internet address input field when a name of a company or a counterpart is unique, related portal websites 9, 11, 10, 13, 15, 20, and 23 can be displayed on the computer or information communication terminal. A simple name is directly converted to an Internet address at a specific site in the same way as is done by a general search engine, or a list of all related multi-dimensional websites of an object relation type, network relation type, unary and extended relation type, and hierarchy type is displayed. In addition, if a certain name is inputted as an address, related multi-dimensional websites can be displayed. For example, names of many business places are registered in order to provide a specific service, in which if a unique name of a business place is inputted at an extended relational multi-dimensional website (e.g., www.name2web.com), the website is directly transferred to the website of the original business place. If the name of the B car sales office 33 in Daejeon is Balbari as shown in FIG. 1 and www.name2web.com/balbari is inputted in the internet address bar within any type web browser, the website is immediately transferred to the website 14 of the B car dealer office in Daejeon www.b.com. Then, if Balbari is inputted in a search field through a search service at a specific website (e.g., www.name2web.com), all related multi-dimensional websites of an object relation type, network relation type, unary and extended relation type, and hierarchy type are displayed. This can be applied to various fields, and if a region, product name, service name, and subject common to contents are known, they can be searched for at the level of Internet address. Therefore, there is provided a multi-relational multi-dimensional Internet data bidirectional management website system using multiple Internet addresses, in which although a correct website name is unknown, a customer can visit the website.

Next, in the multi-relational multi-dimensional Internet data bidirectional management website system using multiple Internet addresses of the present invention, a website corresponding to desired contents, region, or business type is automatically displayed on the mobile telecommunication terminal 22 of a customer in response to a request of the customer and thus can be inputted and updated, in the websites 2, 14, and 26 and the multi-relational multi-dimensional bidirectional websites 9, 11, 10, 13, 15, 20, and 23 using multi-Internet address.

That is, in the multi-relational multi-dimensional Internet data bidirectional website management system using multiple Internet addresses of the present invention, the Internet server 5 and the database 4 automatically displays a website corresponding to desired contents, region, or business type, and the like on the mobile telecommunication terminal 22 of a customer in response to a request of the customer, and inputs and updates contents of the website, in the websites 2, 14, and 26 and the multi-relational multi-dimensional bidirectional websites 9, 11, 10, 13, 15, 20, and 23. To this end, a GPS coordinate of the mobile telecommunication terminal 22 and special character buttons, numeric buttons, and formalized push buttons of the mobile telecommunication terminal are arranged, and the Internet server 6 connected to the mobile telecommunication base station 21 and the mobile telecommunication company system server 24 of each mobile telecommunication company system converts the information of the mobile telecommunication terminal. Particularly, a customer can connect to websites of companies and customers by utilizing phone numbers stored in the mobile telecommunication terminal and special character buttons. In the same manner, since an e-main address includes a web Internet address and an account of the mobile telecommunication terminal 22 of a customer, if an e-main is sent using special characters after combining a phone number and a mobile telecommunication phone number, information on the mobile telecommunication terminal inputted in an e-mail server 26, which is connected to the mobile telecommunication base station 21 and the mobile telecommunication company system server 24 of each mobile telecommunication company system, is converted, and the e-mail is transmitted. In the same manner, if a button is pressed after inputting a simple contents name, address, business type, region, product information, service name and the like in the mobile telecommunication terminal 22, together with special characters or symbols, the multi-dimensional websites 9, 11, 10, 13, 15, and 20 are displayed.

Particularly, when a customer requests for a service by pressing a special button or the like of the mobile telecommunication terminal 22 while moving, the mobile telecommunication station 21 and the mobile telecommunication company system server 24 of the mobile telecommunication company system transmit the GPS coordinate of the mobile telecommunication terminal 22 to the Internet server 6. A GPS coordinate stored in the database 4 is referenced, and nearby multi-dimensional websites are displayed on the mobile telecommunication terminal of the customer. Accordingly, if the customer connects to a local website 9, grasps location of a store, and purchases or reserves product, the customer can easily obtain information on off-line stores even while moving, and thus commercial transactions can be actively made.

Next, in the multi-relational multi-dimensional Internet data bidirectional website management system using multiple Internet addresses of the present invention, in a case where a user s request for multi-dimensional sharing is received through a website or a personal website registered in the database 4, if the Internet server 6 transmits a joining request data to a computer 14 or a mobile telecommunication terminal 29 of a manager of each enterprise or personal site or a decision maker who determines acceptance of the joining request, through the mobile telecommunication company system 24 and the mobile telecommunication base station 21, the decision maker searches for a desired relation criterion from the database 4 of the Internet server 6 and transmits characters or Internet data for permitting the request of adding a relation, and the Internet server 6 transmits the permission data to the information communication terminal 27 of the new member 3 and notifies the permission data to the manager of each multi-relational multi-dimensional specialty Internet contents company 9, 11, 10, 13, 15, 20, and 23 through the Internet server 6.

That is, in the multi-relational multi-dimensional Internet data bidirectional website management system using multiple Internet addresses of the present invention, a company or an individual who desires a new multi-dimensional sharing relation with other companies through multiple relations transmits a request for joining the relation to companies 12, 33, or 34 or personal websites, which are registered in the multi-relational multi-dimensional Internet data bidirectional website management system using multiple Internet addresses and being in a sharing relation, from a computer 3 or an information mobile telecommunication terminal 27 of the individual or company through the mobile telecommunication company system 24 and the mobile telecommunication base station 21, by way of an existing multi-relational multi-dimensional website or personal website that is registered in the database 4 of the server 6. Then, the connected Internet server 6 transmits joining request data to the computer 14 or mobile telecommunication terminal 29 of a manager of a company or personal website or a decision maker, who determines acceptance of the joining request, through the mobile telecommunication company system 24 and the base station 21. The decision maker searches for a desired relation criterion from the database 4 of the Internet server 6 and transmits characters or Internet data permitting the request for additionally joining the relation. The Internet server 6 transmits the permission data to the information communication terminal 27 of the new member 3 through the mobile telecommunication company system 24 and the base station 21 and notifies the data to the manager of the multi-relational multi-dimensional specialty Internet contents company 9, 11, 10, 13, 15, 20, and 23 through the Internet server 6. Since new members are accepted through a variety of channels and multiple relations, an e-mail transferred to a related individual, company, or the like using Internet and e-mail addresses created from the phone number, mobile telecommunication phone number, and the like in a multi-relational multi-dimensional structure as shown in claim 2 is transmitted to an individual after confirming personal information of a relation structure, and thus a spam mail can be immediately identified. That is, the multi-relational multi-dimensional Internet data bidirectional website management system using multiple Internet addresses becomes a spam mail prevention system.

Next, in the multi-relational multi-dimensional Internet data bidirectional website management system using multiple Internet addresses, the Internet server 6 can construct websites for all individuals, a multi-dimensional personal website 11 hierarchically related to companies, and a network relation type multi-dimensional community site where the personal sites are associated with one another, independently using information such as a phone number, as an Internet address.

That is, in the multi-relational multi-dimensional Internet data bidirectional website management system using multiple Internet addresses of the present invention, it is possible to independently construct websites for all individuals, a multi-dimensional personal website 11 hierarchically related to companies, and a network relation type multi-dimensional community site where the personal sites are associated with one another, using information such as a phone number as an Internet address, through the Internet server 6. When such personal websites are constructed, using Internet IP phone-VoIP 32 installed in the computer 31 of a customer, all the related companies and individuals can freely communicate through bidirectional communication equipment, i.e., Internet phones VoIP, connected to the Internet phone server 30. As described above, information on a company or personal information of an individual is stored in the database 4 of a company's or individual's website 2, 14, 26, and 11. If information on sharing the personal information is added to the personal or company website through the communication terminal 22 connected to the Internet server 6 without the need of exchanging name cards when meeting a staff of the company, personal data configured based on a network relation criterion is added to the personal contents of the website of the customer or the staff, and the data is shared. The customer and the company register the personal information into the website in a multi-dimensional structure, share the registered information, and transmit and receive the information in the multi-dimensional structure of a relational type. The customer and the staffs of the companies can use the Internet phone 32 service through the mobile telecommunication terminal 22 connected to the web, using the personal data shared among the websites 2, 14, 26, and 11. If further more information communication terminals are connected to a personal website by connecting the information communication terminals to websites of bidirectional communication equipment IP TVs, remote conferences, remote diagnoses, IPTV broadcast stations, companies, hospitals, and the like in a multi-dimensional structure of a relation type, the personal website, i.e., a multi-dimensional relation type contents management system, functions as a personal integrated media center of an information communication system.

Next, in the multi-relational multi-dimensional Internet data bidirectional website management system using multiple Internet addresses of the present invention, the Internet server 6 includes a plurality of databases 4, independently creates a plurality of individual websites for a plurality of individuals using personal information and company information such as a phone number as an Internet address through a hierarchy relational multi-dimensional Internet data bidirectional management website system, constructs a multi-relational multi-dimensional website of immovables, such as, houses, buildings, towns, and the like, and movables, such as vehicles, buses, computers, TV, and the like, by multiply relating the created individual websites, and creating a remotely managed website for providing multiple channels using different names as Internet addresses.

That is, in the multi-relational multi-dimensional Internet data bidirectional website management system using multiple Internet addresses of the present invention, the Internet server 6 and a plurality of databases 4 are created, and a plurality of private personal websites are created for a plurality of individuals using personal information such as phone number as an Internet address through a hierarchy relational multi-dimensional Internet data bidirectional management website system. Immovables, such as houses, buildings, towns, and the like and movables such as vehicles, buses, computers and the like are constructed as a multi-relational multi-dimensional website by multiply relating the created personal websites. In this manner, a remotely managed website for providing multiple channels is constructed using different names as Internet addresses. Such a site constructs a website in multiple relations with multi-dimensional websites of the other individuals and companies and makes it possible to manage the movables and immovables by a communication system connected to the Internet.

Particularly, the mobile telecommunication terminal 22 of a customer connected to the Internet connects to a multi-dimensional personal website 11 of a hierarchy relation through the mobile telecommunication company system 24 and the mobile telecommunication base station 21, monitors situation in a house through the home page of a multi-relational website of the house, and transmits control data to the home computer 14 connected to the Internet and a mobile telecommunication device 29 of a communication terminal connected to the computer, and thus a multi-relational multi-dimensional real estate website can remotely control all kinds of equipment in the house through a website of the house.

Next, in the multi-relational multi-dimensional Internet data bidirectional website management system using multiple Internet addresses of the present invention, each of websites 2, 14, and 26 that use different Internet addresses is provided with a that stores relation points between a company 12 and related other companies or customers or results of using websites 9, 11, 10, 13, 15, 20, and 23 for which different customers use different Internet addresses, records transaction relations, the number of connections, or usage of a customer in each website, allows companies or individuals having a point larger than a certain point to receive an advertisement fee from a company that desires a relation of sharing new contents, and transmits the points of a company or individual and usage result of a user to each of the mobile telecommunication terminals 29 and 22, and the Internet server 6 that is configured to transmit characters or graphic data to the mobile telecommunication terminal 22 through the mobile telecommunication company system 24 transmits a coupon of a character or graphic form to the mobile telecommunication terminal 22 of the customer depending on the usage result of the customer so that the customer can use the coupon when the customer uses a multi-dimensional website 10 using a different Internet address.

That is, in the multi-relational multi-dimensional Internet data bidirectional website management system using multiple Internet addresses of the present invention, the database of websites 2, 14, and 26 that use different Internet addresses stores relation points between a web company 12 and related other companies or customers or results of using websites 9, 11, 10, 13, 15, 20, and 23 for which different customers use different Internet addresses. Transaction relations, the number of connections, or usage of a customer is recorded in each website, and companies or individuals having a point larger than a certain point may receive an advertisement fee from a company 9 that desires a relation of sharing new contents. The points of a company or individual and usage of a user can be transmitted to each of the information communication terminals 29 and 22, and since the Internet server 6 is configured to transmit characters or graphic data to the wireless communication terminal 22 through the mobile communication company s repeater 24, the Internet server can transmit a coupon of a character or graphic form to the wireless communication terminal 22 of the customer depending on the usage of the customer so that the customer can use the coupon when the customer uses a multi-dimensional website 10 that uses a different Internet address.

### Advantageous Effects

According to the present invention as described above, one or more websites 2, 14, and 26 establish multiple relations (object relation type, network relation type, unary relation type, extended relation type, and hierarchy relation type) utilizing a variety of Internet addresses, and a customer connects to multi-dimensional websites 9, 11, 10, 13, 15, 20, and 23 categorized in a variety of multi-dimensional arrays (horizontal, vertical, parallel, series, upper and lower arrays, and the like) by contents, type, region, and business type based on relation criteria. Therefore, the present invention is advantageous in that a user can easily obtain information on services or goods that can be used or purchased in the user s region, and as needed, easily search for a region where services or goods needed by the user are provided, analyze a variety of information on the Internet, and easily access to specialized information, and thus the user can reduce web access time.

Further, if a customer inputs the name of a site that automatically converts the name of the region where the customer lives to an Internet address of a multi-relational multi-structure website in combination with the name of the region, e.g., inputs www.name2web.com/seoul in the internet address bar within any type web browser the customer can connect to a local specialty portal 9-1 and select and order desired goods or services. In this manner, a customer can directly connect to a desired site by imputing a website name in the internet address bar within any type web browser, together with a name that can be multi-dimensionally analyzed, in a variety of cases. Particularly, since the customer uses a specialty shopping-mall 10 by further subdividing the websites 9 distributed in each region, and connects to a plurality of multi-relational multi-dimensional specialty portals 9, 11, 10, 13, 15, 20, and 23 with one input, there can be more chances of transactions from the viewpoint of companies. It is possible to order vegetables, foods, and the like that are difficult to treat in a conventional centralized Internet shopping-mall and need prompt delivery, and the present invention is advantageous in that features of the region can be promoted. Particularly, since on-line websites and off-line stores are interconnected and the infrastructure among the websites and stores is shared, there is an advantage in that new service can be provided to customers.

Furthermore, since the server 6 is configured to transmit characters or graphic data to the information communication terminal 22 of a customer through the mobile telecommunication company system 24, when the customer connects the mobile telecommunication terminal to the Internet, inputs a simple delimiter and writes a phone number, contents information related to a company or characters of contents that can be multi-dimensionally analyzed, the mobile telecommunication terminal can be connected to a desired multi-relational multi-dimensional website having a different related Internet address. This is also possible in a computer connected to the Internet, and all search conditions can be made in the internet address field of the web browser internet address bar. That is, after constructing websites 2, 14, and 26 in a network relation form, the companies 12, 33, and 34 can construct a website 13 having a plurality of Internet addresses, such as different characters or phone numbers, as a unary relational multi-dimensional website, an extended relational multi-dimensional website portal 15 by adding other contents to the unary relational multi-dimensional website, and a hierarchy relation unary relational multi-dimensional website 11 that is connected to customers. As described, a multi-dimensional website of an object relation type, network relation type, unary relation type, extended relation type, or hierarchy relation type is constructed in an integrated and composite manner in association with all the other websites, and a contents type, region, business type, and the like are adopted as relation criteria so that the website can be multi-dimensionally analyzed. An array of the structure is arranged in a horizontal, vertical, series, parallel, upper, or lower structure. Since such a multi-dimensional specialty site can be indefinitely expanded and it is possible to search for a web business through the internet address bar within any type web browser, there are further more chances to have more transactions.

In addition, each of the hierarchy relational multi-dimensional websites 11 is constructed as a lower structure website 11 using an Internet address associated with information related to a customer such as a phone number to be connected to a website 26 of an upper structure, and a community function for creating and consuming contents by customers, which is a characteristic of Web 2.0, is created. Therefore, further aggressive marketing can be exercised in each company site 26, and opinions of customers can be immediately reflected, so that the customers can be faithful to the website. Here, each of the lower structures can be constructed as a customer site of a lower structure of another layer, and thus target marketing is possible. Then, websites 2, 14, and 26 can associate with websites of other companies and simultaneously provide service to websites 9, 11, 10, 13, 15, 20, and 23 in a specialty portal site. From the viewpoint of companies, since information is displayed on a large number of associated websites by one input, effect of advertisement will be higher than those of the other media. Therefore, it is effective in that extra advertisement fee can be saved. Particularly, web advertisement on large-scaled web search companies or Internet shopping-malls is not needed, and further effectively, if a large number of personal websites 11 of customers are secured, it is possible to receive an advertisement fee on the contrary. In addition, the Internet server 6 secures the mobile telecommunication terminal number and GPS coordinates of the companies 2, 14, and 26 of a customer stored in the database 4 considering mobility of the customer, and if the customer requests the information in moving or in advance, the Internet server 6 receives the GPS coordinates of the mobile telecommunication company system 24 and transmits a nearest local specialty portal 10 to the mobile telecommunication terminal 22 of the customer. Maps, pictures of the stores, and prices in the stores are displayed on the local specialty portal 10 so that customers can compare the locations, reservation states, and services of off-line companies. Therefore, although the customers travel to the region without knowing information on the region, if the customers use the local specialty portal 10, the Internet server transmits data to the mobile telecommunication terminal 22 of the customers, and thus new services can be provided to the customers in association with off-line companies. Furthermore, if simple words or basic information on the related companies such as a phone number, address, or the like is inputted in the internet address bar within any type web browser for inputting an Internet address, a desired website can be immediately searched for, and since the search engine multi-dimensionally analyzes the information, the present invention functions as a new system substituting for existing search engines.

### BRIEF DESCRIPTION OF THE DRAWINGS

FIG. 1 is a view showing the configuration of a multi-relational multi-dimensional Internet data bidirectional website management system using Internet addresses according to the present invention.

FIG. 2 is a view showing the database configuration of the multi-relational multi-dimensional Internet data bidirectional website management system.

FIG. 3 is a view showing the configuration of a multi-dimensional bidirectional contents management system.

FIG. 4 is a view showing the configuration of a base home page file database.

### BEST MODE FOR CARRYING OUT THE INVENTION

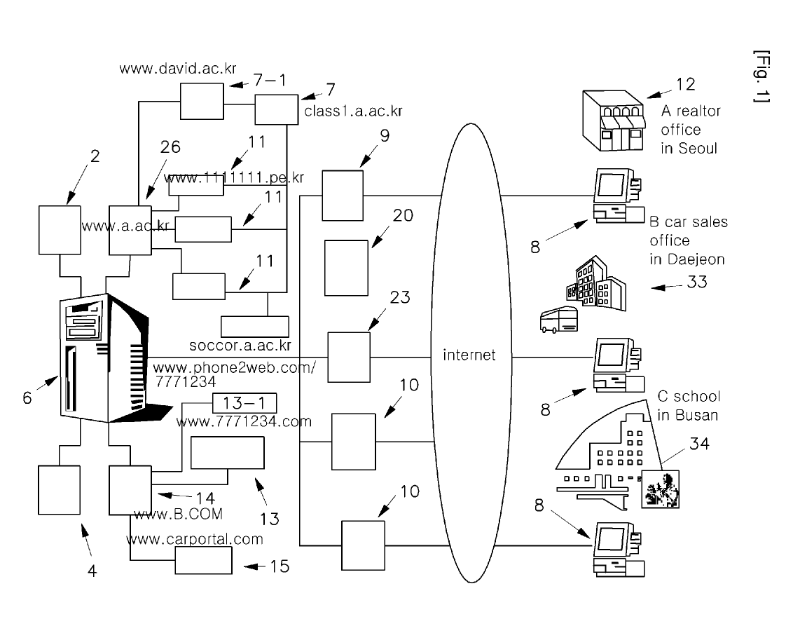

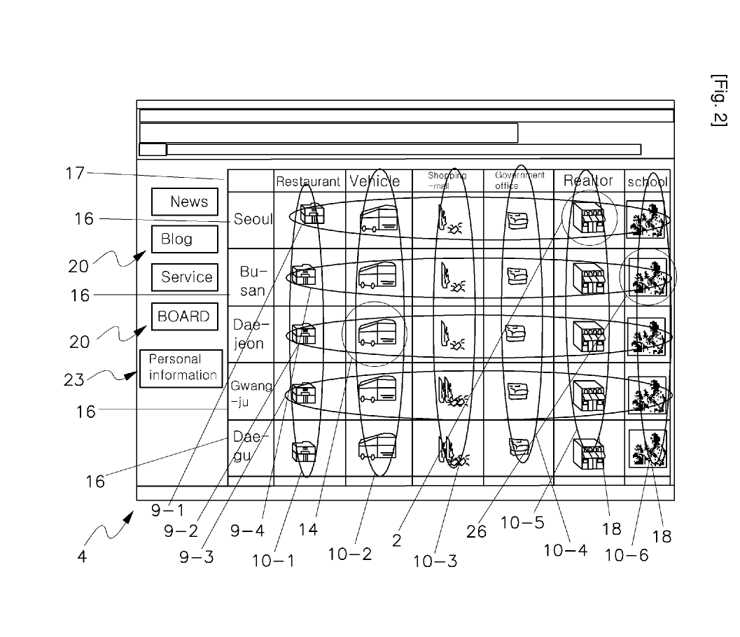

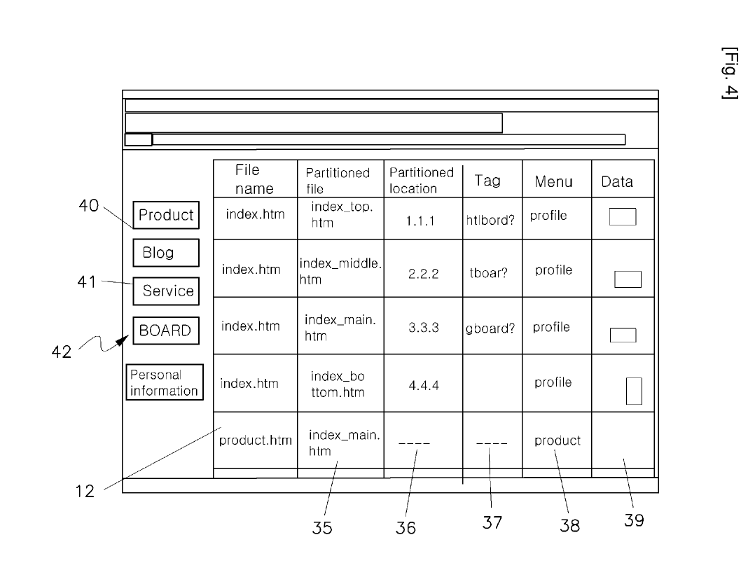

According to the present invention, FIG. 1 shows an example of a structure loading multi-dimensional websites of one or more companies operated by an operator, e.g., three companies including an A realtor office 12 in Seoul, a B car sales office 33 in Daejeon, and a C school 34 in Busan, i.e., websites of the A realtor office, B car sales office, and C school 2, 14, and 26, and more websites can be added to the structure. In FIG. 4, the entire home page display area of a base file, (e.g., index.html,) and each menu file among the home page file (e.g.,,HTML: hyper text markup language, of the website 2 of the realtor office 12 in Seoul is divided into a plurality of partitions by an Internet program, and each of the partitions is assigned with a different partition file name 35 depending on the position. Position information 36, tag information 37, corresponding data information 39, image information, and the like of each partition are formalized or constructed as a database, and partitioned configuration of the base file can be applied by the configuration menu (profile, product, service, contact us, etc.) file of each home page. In connection and relation to the partitions, product information 40, service information 41, cafe board 42, blog, picture information, news information, RSS information, multimedia, and the like, which are Internet data of the site, are formalized or constructed as a database as shown in FIG. 4. In this method, FIG. 2 shows that other websites 14 and 26 and a large number of the other websites are formalized in the form of an object or constructed as a database and divided on the basis of common relation criteria of each object. The websites are partitioned into a group array of a multi-dimensional structure. Internet data of each menu, contents type, region, and company of the home page and a variety of data such as product information, service information, caf, board, blog, picture information, news information, personal information, RSS, multimedia information, and the like are used as relation criterion keys depending on the object relation criterion type, and the websites are generated as groups based on the relation criterion keys. Each of the groups is formalized or constructed as a database in the form of an array.

As shown in FIG. 1, the entire system comprises one or more(connected by internet) Internet server 6 including a database 4 for storing a plurality of Internet sites based on relation criteria and Internet terminals 8 of customers connected to the Internet server 6 through the Internet. As shown in FIGS. 1 and 2, a database of the A realtor office website 2 in Seoul is constructed in an object form based on the database 4, and databases of the other websites registered in the a server are also created in the form of an object. Only real estate businesses, i.e., a relation criterion of an object form, are selected from each of the databases and formalized as a group 18 depending on an object array, and then database arrays are created as shown in FIG. 2 and created as database groups formed based on the arrays. The base file(index.html) constructed as a portal site of a new design is divided into a partitioned structure as shown in FIG. 4, and the database groups formalized in an object relation array are applied to various menus of a home page as HTML tags in display parts of an Internet browser, or a program is used in order to display real estate data such as information on goods and services. The website of the A realtor office in Seoul is added to the database group as an object. As a result, in FIG. 2, a multi-dimensional website constructed by grouping only the real estate businesses of object group 18 in an object relation structure becomes a nationwide realtor office portal site 10-5.

In the same manner, a plurality of websites are created in the form of a plurality of objects, and a local specialty website of a multi-dimensional structure, i.e., a Seoul area business place portal site 9-1, a real estate specialty blog portal site 20 that is a contents specialty website, and a real estate specialty agent portal site 23 are constructed by selecting objects having the same relation key and arranging the objects in relation groups. Here, Internet data of the A realtor office in Seoul is included in the multi-dimensional website in an object form. The object relational multi-dimensional website is characterized in that real estate items for sale and blog data uploaded by a customer, staff, or agent of the A realtor office website in Seoul 2 are automatically shared, added, and updated in the nationwide realtor office portal site 10-5, Seoul area business place portal site 9-1, real estate specialty blog portal site 20, and real estate specialty agent portal site 23. That is, if data is inputted only once through the A realtor office website in Seoul, the data is displayed and bidirectionally updated in the four object relational multi-dimensional websites, and thus Internet data is shared, added, and updated.

In the same manner, Internet data automatically shared among the nationwide car sales office portal website 10-2 and the nationwide school portal website 10-6, which are multi-dimensional business specialty websites, Daejeon area business place portal website 9-2 and Busan area business place portal website 9-3, which are multi-dimensional regional specialty websites, and car specialty blog website 20, school specialty blog website 20, car sales agent portal website 23, and teacher portal website 23, which are contents specialty multi-dimensional websites, is added, updated, and shared in the website of the B car sales office 14 in Daejeon and the website of the C school 26 in Busan through the database 4 depending on object relation criterion key of each website. All the Internet sites constructed in a multi-dimensional structure become an object relational multi-dimensional Internet data bidirectional management system that considers a site as an object.

As described above, each of all the Internet sites can be constructed by indefinitely modifying a multi-dimensional Internet site through the database 4 depending on existence and criteria of a relation, regardless of conditions. The same site can be copied and constructed in a unary relation structure to be shared, added and updated using a different Internet address.

The constructed unary relational multi-dimensional Internet site can be used through a different Internet address and can be constructed to be easily searched for by adding related information to the Internet address. For example, the Internet address of the website of the B car sales office in Daejeon 14 (e.g., www.b.com) can be modified to another Internet address including a phone number, related information, and the like in order to create the same website 13 (e.g., www.7771234.com), which becomes a unary relational multi-dimensional Internet data bidirectional management system.

In addition, it is possible to construct an extended relational multi-dimensional car specialty portal website 15 (e.g., www.carportal.com) by additionally inputting Internet data related to cars in the website of the B car sales office 14 in Daejeon and processing the Internet data, which becomes an extended relational multi-dimensional Internet data bidirectional management system.

In the same manner as creating a plurality of multi-dimensional websites 9, 11, 10, 13, 15, 20, and 23, Internet data stored in the base websites 2, 14, and 26 establishes a network relation with Internet sites that show the best effect among the relational database 4 constructed in a multi-dimensional structure of all websites that are registered in each server, and the Internet data is divided into shared data and unshared data. Internet data of each base website 2, 14, or 26 is shared with related companies as Internet data, and existing unique Internet data is inputted into each of the websites 2, 14, and 26, and thus latest Internet data of the related companies is periodically updated and added in real-time. This becomes a network relational multi-dimensional Internet data bidirectional management system.

Particularly, the website 26 of the C school in Busan formalizes information on the school, region, blog, news, students affairs, and home assignments into a database in itself, and information related to students among the data contained in menus is preferentially created in an Internet relational database in a hierarchy relational multi-dimensional structure and registered to be shared, so that the Internet site 11 of each student registers all contents in the shared database 4. Information on the home assignments and student affairs of a student is registered in the database, and all contents of the assignment information are inputted in the shared database related to the website 11 of the student.

An Internet site of a lower structure in such a hierarchical relation focuses on a personalized Internet site of a student and constructs all related information as a database. Among information on the upper and lower structure Internet sites, information corresponding to relation criteria is rendered first and created as a relational structure of another lower structure database in a hierarchy relational multi-dimensional structure. For example, a plurality of class Internet sites 7 of a lower structure are constructed by combining class information, which is a hierarchy relation key structure common to a school. In the same manner, students in the same class, i.e., a relation criterion common to a hierarchy, respectively create an Internet site and share class contents in the class Internet site. Describing further specifically, a can be created as shown below by applying information related to students to information on the websites of the students as a relation criterion. Class information is created in the class website 7 as a relation criterion, and a website 7 can be created for each class. Then, class information of a student database is rendered as a relation criterion key and shared in a multi-dimensional relation such as the class database, and if the student website 11 is the same class, the student website is automatically and bidirectionally associated with the website of each class.

For example, as shown in the following table, since Tom, Bin, and Kim are in the same class, they are automatically registered in the class 1 site 7 to register and share information on their assignments. Particularly, if an assignment or important announcement is posted once on the class 1 in the website 7-1 of teacher David, which is another common relation key, the students can view those together with parents, and thus home pages are effectively associated.

Database information of student Internet site

| Student | | | | Phone | Teacher's | Assignment |
|---|---|---|---|---|---|---|
| information | Grade | Class | Hobby | number | name | data |
| TOM | A | Class1 | Soccer | 1111111 | DAVID | TTT |
| JANE | B | Class2 | Soccer | 4444567 | SON | DDD |
| BIN | B | Class1 | Basketball | 7777777 | DAVID | TTT |
| PAUL | A | Class3 | Basketball | 8888888 | JUN | CCC |
| KIM | A | Class1 | Soccer | 1234567 | DAVID | TTT |

Database information of class Internet site

| Class | | | | | Teacher's | Assignment |
|---|---|---|---|---|---|---|
| information | Student1 | Student2 | Student3 | Student4 | name | data |
| CLASS1 | TOM | BIN | KIM | | DAVID | TTT |
| CLASS2 | JANE | . . . | | | SON | DDD |
| CLASS3 | PAUL | . . . | | | JUN | CCC |

In addition, Internet data of the website 26 of the C school in Busan is shared and associated with each class website, and all information created by students can be viewed except security information.

Another hierarchy relational multi-dimensional community site can be created utilizing personal information of each student.

As an example of the personal information, if a student whose hobby is soccer posts his or her information on a public relation criterion, an Internet site of those whose hobby is soccer is automatically created, and each of the students can upload soccer-related contents on his or her site. A multi-dimensional soccer community site, which is another hierarchy relation type, accepts another community member through soccer contents of a personalized home page that is created in each day. As described, students discuss an issue or construct a community, blog, RSS, or the like starting from the base of the personalized home pages. This becomes a hierarchy relational multi-dimensional Internet data bidirectional management system.

Describing further specifically, the multi-relational multi-dimensional Internet data bidirectional website management system is largely divided into an object relation type, unary relation type, extended relation type, network relation type, hierarchy relation type, and the like, and a plurality of relation types can be compositely applied. Such multi-relation types are formalized in a multi-dimensional array or constructed as a database, and respectively matched to multi-dimensional websites using multiple Internet addresses. Since all existing websites can be represented in a multi-dimensional structure, and the relational array of all Internet data is bidirectional by nature, it is important to determine the way of establishing a relation, the type of common relation with other structures, and relation criteria to be used as a key. It is important to determine how to sort and arrange Internet data in a multi-dimensional structure within multiple relations in order to display multi-dimensional websites on an Internet browser.

There are many kinds of multi-dimensional arrays in each multi-relational Internet data bidirectional management system. First, there is a vertical and horizontal array structure in an array of an object relational multi-dimensional structure, and object relation keys of any of contents and business types can be arranged in vertical and horizontal directions. As an example of the vertical and horizontal array, a plurality of shopping-mall websites partitioned based on a business type are considered as objects. The objects form a group, and shopping-mall specialty portal websites 10-3 are divided in the form of a vertical array to form a shopping-mall site object group as shown in FIG. 2. In the same manner, other business specialty portal sites 10 using different Internet addresses, such as a nationwide car sales office web portal site 10-2, a nationwide school web portal site 10-2, and the like, are created using a plurality of websites of all business types. Shared contents inputted from websites 2, 14, and 26 and other websites and Internet data inputted from other websites of the same business type are automatically added and updated in the multi-dimensional business specialty portal sites 10 in real-time, and thus a business specialty analysis portal site desired by customers can be easily created. In addition, as a horizontal array shown in FIG. 2, there can be a variety of object relation criterion keys categorized by the region, contents type (news, blog, caf, board, and club), and the like, and information on the contents of a region or other contents 16 created by the blog or the like are created in another region specialty portal site 9, so that each of specialized areas can be multi-dimensionally analyzed using a plurality of different Internet addresses in order to display information on a company corresponding to a special search condition by the type of contents.

Therefore, it is possible to construct a website in which a customer can specifically analyze a variety of desired information and compare prices of merchandise by the business type.

Second, there is an upper and lower structure in an array of a hierarchy relational multi-dimensional structure, and hierarchical websites can be constructed using different Internet addresses for customers or companies having a business relationship in the upper and lower structure. A lower structure website constructs multi-dimensional lower websites for customers or companies having a business relationship through another hierarchical relation, and constructs channels for collecting marketing information contents of customers and companies having a business relationship by selectively sharing contents uploaded from websites of a lower structure or utilizing data that can be bidirectionally inputted and updated. In addition, there is provided a multi-relational multi-dimensional Internet data bidirectional website management system using multiple Internet addresses, in which an upper website inputs related new information once a day and shares the information with websites in the entire lower structures, thereby maximizing marketing and advertisement effects. In the hierarchy relational array, an upper and lower structure of a parallel, series, horizontal, or vertical array structure is compositely or independently progressed.

Third, there is a parallel structure in an array of a network relation type multi-dimensional structure, in which Internet data of one website is periodically updated and added to another website when relation criterion keys are not related among one or more existing websites or through a strategic association, and thus intervals for periodically updating Internet data in each website is reduced. If further more websites are connected in parallel in the network relation type multi-dimensional structure, new contents are periodically created everyday in each website, and thus it is effective in that visitors to the websites are increased.

Fourth, since a multi-dimensional website of a unary and extended relation type is a concept of constructing the same website of a website using different Internet addresses, the multi-dimensional website is close to a series structure. Such a unary and extended relation type website creates further more website channels, and thus it is effective in that visitors to existing websites are increased.

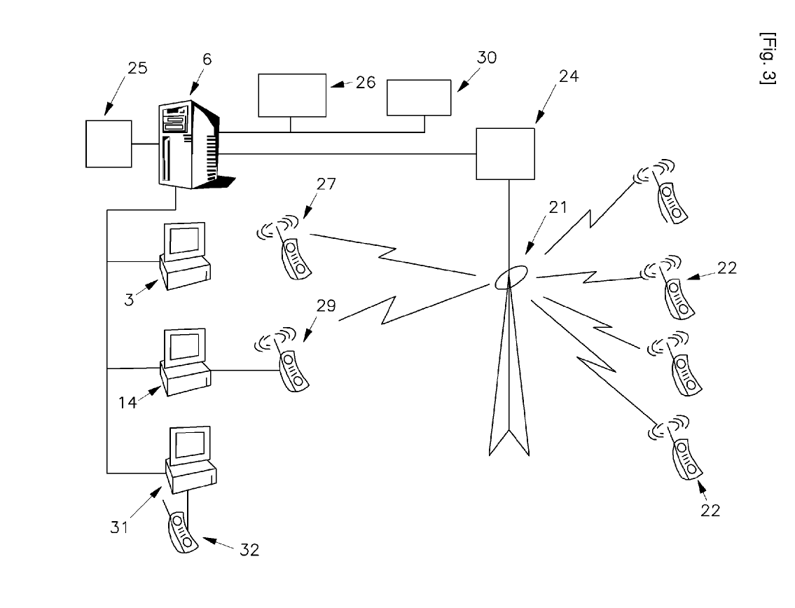

According to another aspect of the present invention, the database 4 of each of the websites 2, 14, and 26 stores a phone number of a mobile telecommunication terminal 22 inputted by an Internet customer. Particularly, the GPS coordinate of each website 12, 33, or 34 is inputted and stored in the database 4 of the website, and the server 6 or the websites 2, 14, and 26 can transmit characters or graphic map data to the mobile telecommunication terminal 22 of a customer. If the customer is close to a store 12 or requests related service, a related GPS system confirms the location of the mobile telecommunication terminal 22 of the customer and displays object type multi-dimensional websites of stores in the neighborhood on the mobile telecommunication terminal 22 connected to the web. For example, when a customer in Seoul visits a place in Daejeon and requests a service to be informed of information on the whole close business places in Daejeon area, GPS and other specific information of the customer are transmitted to the server 6, and the customer can view a Daejeon area business place portal website 9-2, which is a object relational multi-dimensional website, on the mobile telecommunication terminal 22 of the customer connected to the Internet, through the mobile telecommunication company system 24 and the base station 21, as shown in FIG. 3 by the database 4. The advantage of such a technique is that a customer can visit a home page of an off-line store located in the neighborhood and view and utilize information on the store in detail wherever the customer is. Using the technique, there is provided a multi-relational multi-dimensional Internet data bidirectional website management system using multiple Internet addresses, in which the server 6 can transmit characters or graphic data to the mobile telecommunication terminal 22 of the customer in order to provide the information that the multi-dimensional website 9, 11, 10, 13, 15, 20, and 23 of each store has completed addition or update of contents, or purchase of product or reservation in an off-line store has been completed, through the mobile telecommunication company system 24 and the base station 21, as shown in FIG. 3.

According to a further aspect of the present invention, the databases 4 of the server 6 or many websites 2, 14, and 26 store personal information, such as a mobile telecommunication terminal number 22 and the like, of each company. If information on sharing personal information is added to the hierarchy relational multi-dimensional website of each person when staffs of companies or people having a hierarchy relational multi-dimensional website meet with each other, without the need of exchanging name cards, through the mobile telecommunication terminal 22 connected to the Internet, the information is merged with Internet personal information stored in the database 4 in the hierarchy relational multi-dimensional website of a customer, staff, student, individual, and the like. The Internet personal information is shared in a website configured in a hierarchy relational multi-dimensional structure, and the customer, individual, and student can confirm a contact point of a person through the shared personal information at each of their websites and contact with the person. In addition, information can be exchanged through the hierarchy relational multi-dimensional website in a parallel relation of a network relation type multi-dimensional array. For example, when students and teachers having a mobile telecommunication terminal 22 connected to the Internet visit a certain school in Seoul through the website 26 of the C school in Busan, the hierarchy relational multi-dimensional websites 11 and 7 is connected to a personal website of a teacher or student of the school in Seoul under a network relational multi-dimensional structure, and a call connection can be established using the personal information shared by connecting the hierarchy relational multi-dimensional websites therebetween. If further more information communication terminals are connected to the Internet, the multi-relational multi-dimensional Internet data bidirectional website management system using multiple Internet addresses can be provided as a further complex relational multi-dimensional website.

According to a still further aspect of the present invention, there are provided a multi-relational multi-dimensional Internet data bidirectional website management system using multiple Internet addresses, in which the databases 4 of the multi-relational multi-dimensional websites 2, 14, and 26 using different Internet addresses store usage points of all companies 12, 33, and 34 in multiple relations and relation point among customers, and particularly, records of customers using multi-dimensional websites 9, 11, 10, 13, 15, 20, and 23 that use different Internet addresses, and the server 6 is configured to transmit information on the points and usage record of the customer to the mobile telecommunication terminal 22 in the form of characters or graphic data through the system 24 of the mobile telecommunication company, and depending on the record of using the website, the server can transmit a coupon of a character or graphic form to the mobile telecommunication terminal 22 of the customer such that the customer can use the coupon when the customer uses multi-relational multi-dimensional websites 9, 11, 10, 13, 15, 20, and 23 that use different Internet addresses.

According to a still further aspect of the present invention, since each of the companies 12, 33, and 34 or the like stores phone numbers or mobile telecommunication phone numbers of customers of all the other companies being in a multiple relation in the database 4 of the websites 2, 14, and 26 that use different Internet addresses, and particularly, there are too many hierarchy relational multi-dimensional websites, i.e., personal websites, it is difficult to distinguish the websites by domain information. Therefore, if hierarchy relational multi-dimensional websites 7 and 11 are constructed using phone numbers as Internet addresses, phone numbers are stored in the phone book of a computer or mobile telecommunication terminal 22 connected to the Internet. Therefore, if another customer loads a phone number of a person and inputs a simple special symbol or delimiter, the special delimiter is recognized, and the computer or mobile telecommunication terminal is connected to the Internet through the mobile telecommunication company system 24. Then, a personal Internet site 7 or 11, i.e., a corresponding hierarchy relational multi-dimensional website, is directly loaded through the server 6.

In the same manner, a phone number of a company, restaurant, business place, motel, travel agency, tour-related business place, public service office, government office, or the like stored in a computer or a mobile telecommunication terminal 22 is considered important, and a business place is constructed as a unary relational multi-dimensional website having a phone number as an Internet address. Then, if a phone number is inputted in a field for inputting an Internet address, the website 2, 14, or 26 of a corresponding company is automatically displayed. For example, as shown in FIG. 1, if the phone number of the B car sale office 33 in Daejeon, which is stored in the database 4 of the web server 6, is 0417771234, in addition to the address www.b.com of the website of the B car sales office in Daejeon, a website that is the same as the website of the B car sales office having an Internet address of www.7771234.com is created using the phone number by the unary relational multi-dimensional Internet data bidirectional website management system. Particularly, another Internet address containing a phone number is created using a specialized unary relational multi-dimensional website system, and the address and phone number of a specific website (e.g., www.phone2web.com) that is specialized to provides a service for associating a phone number with an Internet address are combined regardless of the method of combination (e.g., www.phone2web.com/7771234 or 7771234.phone2web.com).

Therefore, an Internet address can be easily searched for only if the phone number is known. This is possible due to a self series structure among unary relational multi-dimensional arrays, i.e., a multi-dimensional website that creates a website 13 or 15 that is the same as the original website 14 through the database 4 of the web server 6. A mobile telecommunication company system can recognize the symbol or delimiter, which is possible if a server of each mobile telecommunication 24 only converts a value of the symbol or delimiter into the address of a website of a company (e.g., www.phone2web.com) that is specialized to provide a service for associating a phone number with an Internet address and uses a different Internet address. Since a lot of people know the phone number of the website 2, 14, or 26 although the Internet address thereof is unknown, a correct website address can be searched for only if the phone number is known.

Particularly, an e-mail address such as 0112223333@7771234.com is created using a phone number or a mobile telecommunication terminal number in the same manner. That is, an account of SMTP and POP servers of the unary relational multi-dimensional website (e.g., www.7771234.com) is created in the server 6, and an e-mail can be transmitted and received using the account. In this method, if a customer knows the mobile telecommunication number of a person to whom the customer desires to send an e-mail from the phone book of the mobile telecommunication terminal 22 connected to the Internet, and inputs a special character, a delimiter, and the mobile telecommunication terminal number of the customer who receives the e-mail without an order, the special character and the delimiter are distinguished through the server 24 of the communication company, and a general phone number (e.g., 7771234) is searched for from the database 4 of the server 6 using the mobile telecommunication phone number (e.g., 0112223333). Then, the account of the mobile telecommunication phone number (e.g., 0112223333) is searched for from the SMPT and POP servers having a unary relational multi-dimensional website of the general phone number (e.g., www.phone2web.com) as an address, and an e-mail is transmitted. As another method, if a website (e.g., www.phone2web.com) that is specialized to convert a phone number to an Internet address as described above is connected to a mobile telecommunication terminal and an e-mail is transmitted to the e-mail address (e.g., 0112223333@phone2web.com), a counterpart's e-mail address or general phone number is correctly searched for from the database 4 of the server 6 that stores the extended relational multi-dimensional website (e.g., www.phone2web.com) of the website of the B car sales office in Daejeon 14, and the e-mail is delivered, for example, to the e-mail address (e.g., 0112223333@7771234.com).

Extending furthermore, if a subject word common to the contents is inputted in the Internet address input field when a name of a company or a counterpart is unique, related portal websites 9, 11, 10, 13, 15, 20, and 23 can be displayed on the computer or mobile telecommunication terminal. A simple name is directly converted to an Internet address at a specific site in the same way as is done by a general search engine, or all websites of an object relation type, network relation type, unary and extended relation type, and hierarchical type is displayed. In addition, if a certain name is inputted as an address, related multi-dimensional websites can be displayed. For example, names of many business places are registered in order to provide a specific service in which if a unique name of a business place is inputted at an extended relational multi-dimensional website (e.g., www.name2web.com), the website is directly transferred to the website of the original business place. If the name of the B car sales office 33 in Daejeon is “Balbari” in FIG. 1, and www.name2web.com/balbari is inputted in the internet address bar within any type web browser, the website is immediately transferred to the website 14 of the B car dealer office in Daejeon www.b.com. Then, if balbari is inputted in a search field through a search service at a specific website (e.g., www.name2web.com), all related multi-dimensional websites of an object relation type, network relation type, unary and extended relation type, and hierarchical type are displayed. This can be applied to various fields, and if a region, product name, service name, and subject common to the contents are known, they can be searched for at the level internet address bar within any type web browser. Therefore, there is provided a multi-relational multi-dimensional Internet data bidirectional management website system using multiple Internet addresses, in which although a correct website name is unknown, a customer can visit the website.

Hereinafter, a variety of embodiments will be described with reference to the accompanying drawings.

FIG. 1 is a view showing the configuration of a multi-relational multi-dimensional Internet data bidirectional website management system using Internet addresses according to the present invention. The multi-relational management system comprises a Internet server 6 having a database 4 for loading a multi-dimensional website of three companies having different Internet addresses managed by an operator, i.e., the A realtor office 12 in Seoul, the B car sales office 33 in Daejeon, and the C school 34 in Busan, and websites of the A realtor office 2, the B car sales office 14, and the C school 26, Internet terminals 8 of customer side connected to the Internet server 6 through the Internet, and companies 12, 33, and 34 corresponding to the websites 2, 14, and 26.

The database 4 of the Internet server 6 stores Internet data of the companies 12, 33, and 34 joined in the multi-dimensional Internet data bidirectional management website, in which if it is possible to assign a relation of an object relation type, network relation type, unary and extended relation type, or hierarchical relation type with other registered websites such as the websites 2, 14, and 26 using different Internet addresses, the Internet data can be shared by a bidirectional website management system based on a relation criterion. A website can be constructed as a plurality of websites using different Internet addresses in the unary and extended relation type. A relation of one or more websites includes the object relation type, network relation type, and hierarchical relation type. In the object relation type, one or more websites using another Internet address having a criterion consider a websites of each company 12, 14, and 16 as an object and can construct bidirectional multi-dimensional analysis websites 9, 10, 20, and 23 by assigning multi-dimensional array contents as a horizontal array relation or vertical array relation depending on a relation criterion. Multi-dimensional analysis contents are created by the subject of contents, business type, and region of the websites 2, 14, and 26 so that the contents can be analyzed, and the contents are divided and stored by the contents type (news, blog, service, cafe, club, free bulletin board, multimedia, company, location, and business type of off-line company. At this time, criteria of vertical and horizontal arrays can be changed with each other. The websites 2, 14, and 26 may include websites of all kinds of business stores, such as stores selling product, travel agencies, performance centers, barber's and beauty shop, and the like, and all kinds of companies, such as Internet shopping-malls, off-line stores, off-line shopping-malls, enterprises, real estate agencies, car dealers, government offices, advertisement companies, hospitals, schools, and the like.

FIG. 2 shows a database table for constructing multi-dimensional websites 9, 10, 20, and 23 considering websites of a plurality of companies including the websites 2, 14, and 26 as objects. Internet data of each object can be analyzed in various points of view, and object information stored in the database 4 of websites, which can bidirectionally communicate and multi-dimensionally analyze the Internet data by using a plurality of different Internet addresses, is arranged on a display unit 17 of the database 4. The display unit 17 of the database 4 is vertically and horizontally partitioned into a plurality of areas 10 using a plurality of different Internet addresses according to the contents type, business type, and region. Internet contents corresponding to conditions on the region and business type of a regional specialty website 10 are shared among the websites 10 and arranged in each of the regions 16. A customer connects to the website 10 and uses a specialized service provided by the specialty portal website 10, and it is configured such that a customer can easily purchase product and compare prices depending on the business type of the specialty portal website 10, create and consume contents such as specialty blog, and reserve and sell products and services of related companies. If a company provides a customer with a personal website 11, which is a hierarchy relational multi-dimensional website, the customer can share and receive desired Internet data without connecting to the websites 2, 14, and 26, and the contents created by the websites 11 of related companies and customers are assembled in the upper structure websites 2, 14, and 26 and used for marketing to customers. Here, the hierarchy relational multi-dimensional lower structure website 11 can create a hierarchy relational multi-dimensional upper and lower structure website 7. Particularly, it is possible to associate with regional specialty shopping-malls 9, 10, 20, and 23, which are object relational multi-dimensional websites, and a customer can easily construct his or her website of a hierarchy relational multi-dimensional structure, purchase product associatively sold by websites of the specialty shopping-malls 9, 10, 20, and 23, and uploads experience on entrance tickets, gift certificates, off-line stores, and the like on each of the websites. At this time, as shown in FIG. 3, the Internet server 6 connects to a payment server 25 of a financial institute, such as a credit card company or a bank, and allows a customer to immediately make a payment for product purchased or reserved at the websites 2, 14, and 26 or the specialty shopping-mall 10.

As shown in FIG. 3, the mobile telecommunication terminal 22 uses a server system of a general mobile telecommunication company, and if a customer connects to the websites 2, 14, and 26 of the companies 12, 33, and 34 and purchases or reserves service, details on the product purchased or reserved by the customer are transmitted to the mobile telecommunication terminal 22 of the corresponding customer through the mobile telecommunication company system 24 and the mobile telecommunication base station 21. Accordingly, in the multi-relational multi-structure websites 9, 11, 10, 13, 15, 20, and 23 of specialty shopping-malls of each business type, product purchased by a customer can be directly delivered to the customer, or a reservation can be accepted, depending on the details of the service or reservation transmitted to the mobile telecommunication terminal 22.

In addition, as described above, the database 4 of the Internet server 6 stores a phone number of a mobile telecommunication terminal 22 previously inputted by the customer and GPS coordinates of companies, and if the Internet server 6 and the mobile telecommunication server 24 request for a list of nearby companies while the customer is moving, the GPS data transmitted from the mobile telecommunication terminal 22 is automatically transmitted to the Internet server 6 through the mobile telecommunication company system 24 and the mobile telecommunication base station 21. Then, a list of companies close to the mobile telecommunication terminal 22 of the customer is configured in the database 4 and transmitted as Internet data of a character or graphic form through the mobile telecommunication company system 24 and the mobile telecommunication base station 21. Particularly, in this case, a nearby regional specialty portal website 9 of an object relational multi-dimensional structure is displayed on the information communication terminal 22 of the customer. Accordingly, if the customer connects to the regional website 9 and purchases or reserves product at a store, the customer can easily obtain information on off-line stores even in moving, and thus commercial transactions can be actively made.

As shown in FIG. 3, a company or individual who desires a new multi-dimensional sharing relation with other companies through multiple relations transmits a request for joining the relation to companies 12, 33, and 34 or personal websites, which are registered in the multi-relational multi-dimensional Internet data bidirectional website management system using multiple Internet addresses and being in a sharing relation, from a computer 3 or an mobile telecommunication terminal 27 of the individual or company through the mobile telecommunication company system 24 and the mobile telecommunication base station 21, by way of an existing multi-relational multi-dimensional website or personal website that are registered in the database 4 of the server 6. Then, the connected Internet server 6 transmits joining request data to the computer 14 or mobile telecommunication terminal 29 of a manager of a company or personal website or a decision maker, who determines acceptance of the joining request, through the mobile telecommunication company system 24 and the base station 21. The decision maker searches for a desired relation criterion from the database 4 of the Internet server 6 and transmits characters or Internet data permitting the request for additionally joining the relation. The Internet server 6 transmits the permission data to the mobile telecommunication communication terminal 27 of the new member 3 through the mobile telecommunication company system 24 and the mobile telecommunication base station 21 and notifies the data to the manager of the multi-relational multi-dimensional specialty Internet contents companies 9, 11, 10, 13, 15, 20, and 23 through the Internet server 6. Since new members are accepted through a variety of channels and multiple relations, an e-mail transferred to a related individual, company, or the like using Internet and e-mail addresses created from the phone number, mobile telecommunication phone number, and the like in a multi-relational multi-dimensional structure as shown in claim 3 is transmitted to an individual after confirming personal information of a relation structure, and thus a spam mail can be immediately identified. That is, the multi-relational multi-dimensional Internet data bidirectional website management system using multiple Internet addresses becomes a spam mail prevention system.

It is possible to independently construct websites for all individuals, a multi-dimensional personal website 11 hierarchically related to companies, and a network relation type multi-dimensional community site where the personal sites are associated with one another, using information such as a phone number as an Internet address, through the large-scaled Internet server 6. When such personal websites are constructed, using Internet IP phone-VoIP 32 installed in the computer 31 of a customer, all the related companies and individuals can freely communicate through bidirectional communication equipment, i.e., Internet phones VoIP, connected to the Internet phone server 30. As described above, information on a company or personal information of an individual is stored in the database 4 of a company's or individual's website 2, 14, 16, or 11. If information on sharing the personal information is added to the personal or company website through the mobile telecommunication terminal 22 connected to the Internet server 6 without the need of exchanging name cards when meeting a staff of the company, personal data configured based on a network relation criterion is added to the personal contents of the website of the customer or the staff, and the data is shared. The customer and the company register the personal information into the website in a multi-dimensional structure, share the registered information, and transmit and receive the information in the multi-dimensional structure of a relational type. The customer and the staffs of the companies can use the Internet phone 32 service through the mobile telecommunication terminal 22 connected to the web, using the personal data shared among the websites 2, 14, 26, and 11. If further more information communication terminals are connected to a personal website by connecting the information communication terminals to websites of bidirectional communication equipment IP TVs, remote conferences, remote diagnoses, IPTV broadcast stations, companies, hospitals, and the like in a multi-dimensional structure of a relation type, the personal website, i.e., a multi-dimensional relation type contents management system, functions as a personal integrated media center of an information communication system.

The large-scaled Internet server 6 and a plurality of databases 4 are created, and a plurality of private personal websites are created for a plurality of individuals using personal information such as phone number as an Internet address through a hierarchy relational multi-dimensional Internet data bidirectional management website system. immovables such as, houses, buildings, towns, and the like and movables such as vehicles, buses, computers, and the like are constructed as a multi-relational multi-dimensional website by multiply relating the created personal websites. In this manner, a remotely managed website for providing multiple channels is constructed using different names as Internet addresses. Such a site constructs a website in multiple relations with multi-dimensional websites of the other individuals and companies and makes it possible to manage the movables and immovables by a communication system connected to the Internet. Particularly, the mobile telecommunication terminal 22 of a customer connected to the Internet connects to a multi-dimensional personal website 11 of a hierarchy relation through the mobile telecommunication company system 24 and the mobile telecommunication base station 21, monitors situation in a house through the home page of a multi-relational website of the house, and transmits control data to the home computer 14 connected to the Internet and a mobile telecommunication device 29 of a mobile telecommunication terminal connected to internet by the computer, whereby a multi-relational multi-dimensional real estate website can remotely control all kinds of equipment in the house through a website of the house.

Since a display unit 17 partitioned by contents, region, and business type in the vertical and horizontal directions is arranged in the database 4 loaded on the server 6 of the multi-relational multi-dimensional Internet data bidirectional website management system using multiple Internet addresses, and all the services provided according to the regions and business types are displayed, the present invention is advantageous in that a user can easily obtain information on services or goods that can be used or purchased in the user's region. Furthermore, the present invention is advantageous in that the user can easily search for, as needed, a region where services or goods needed by the user are provided. Furthermore, if a customer inputs the name of a site that automatically converts the name of the region where the customer lives to an Internet address of a multi-relational multi-structure website, in combination with the name of the region, e.g., inputs www.name2web.com/seoul in the internet address bar within any type web browser, the customer connects to a local specialty portal 10 and can select and order desired goods or services. In this manner, a customer can directly connect to a desired site by imputing a website name in the internet address bar within any type web browser, together with a name that can be multi-dimensionally analyzed, in a variety of cases. Particularly, since the customer uses a specialty shopping-mall 10 by further subdividing the websites 10 distributed in each region, and connects to a plurality of multi-relational multi-dimensional specialty portals 9, 11, 10, 13, 15, 20, and 23 with one input, there can be more chances of transactions from the viewpoint of companies. It is possible to order vegetables, foods, and the like that are difficult to treat in a conventional centralized Internet shopping-mall and need prompt delivery, and the present invention is advantageous in that features of the region can be promoted. Particularly, since on-line websites and off-line stores are interconnected to each other and the infrastructure among the websites and stores is shared, there is an advantage in that new service can be provided to customers.

Furthermore, since the server 6 is configured to transmit characters or graphic data to the information communication terminal 22 of a customer through the mobile telecommunication company system 24, when the customer connects the mobile telecommunication terminal to the Internet, inputs a simple delimiter and writes a phone number, contents information related to a company or characters of contents that can be multi-dimensionally analyzed, the mobile telecommunication terminal can be connected to a desired multi-relational multi-dimensional website having a different related Internet address. This is also possible in a computer connected to the Internet, and all search conditions can be made in the address field of the web browser address bar. That is, after constructing websites 2, 14, and 26 in a network relation form, the companies 12, 33, and 34 can construct a website 13 having a plurality of Internet addresses, such as different characters or phone numbers, as a unary relational multi-dimensional website, an extended relational multi-dimensional website portal 15 by adding other contents to the unary relational multi-dimensional website, and a hierarchy relation unary relational multi-dimensional website 11 that is connected to customers. As described, a multi-dimensional website of an object relation type, network relation type, unary relation type, extended relation type, or hierarchy relation type is constructed in an integrated and composite manner in association with all the other websites, and a contents type, region, business type, and the like are adopted as relation criteria so that the website can be multi-dimensionally analyzed. An array of the structure is arranged in a horizontal, vertical, series, parallel, upper, or lower structure. Since such a multi-dimensional specialty site can be indefinitely expanded and a search for a web business can be allowed through the internet address bar within any type web browser, there are further more chances to have more transactions.

### INDUSTRIAL APPLICABILITY

According to the multi-relational multi-dimensional Internet data bidirectional website management system using multi-Internet addresses of the present invention, a variety of contents of related shopping-malls, off-line stores, enterprises, government offices, advertisement companies, schools, Internet shopping-malls, and the like can be shared and associated with one another in each website, and customers construct their own website using an Internet address such as a phone number different from those of others and establish a relationship with the contents of the related companies, so that all the customers can easily access the Internet contents of a variety of companies, and all information communication terminals of the customers can associate and analyze those websites, thereby intensifying update, management, specialty, diversity, and marketing of each website where customers can easily visit.

1. A multi-relational, multi-dimensional Internet data and bidirectional website management system(s) using multi-Internet addresses, which comprised with following criteria:
an Internet server (6) provided with a database (4) for storing data;
companies (12, 33, 34) and websites (2, 14, 26) registered in the Internet server (6);
Internet terminals (8) of the companies and customers capable of connecting to the Internet server (6) through the Internet;
wherein the Internet server (6) partitions a base file of a home page file of a registered website (2) by a type of contents, such as a configuration menu (profile, product, service, contacts-us, etc) of an entire display area of each home page file, using an Internet program(ASP), categorizes the partitions by a different partition name (35) depending on a position, formalizes information such as position information (36), tag information (37), corresponding data information (39), and image information, and the like or constructs the information as a database, allows applying partitioned configuration of the base file depending on a relation type, creates data that can be shared bidirectionally by connecting the website data formalized or constructed as a database, based on a variety of relation criteria, assigns a variety of different Internet addresses thereto, and creates multi-dimensional bidirectional websites (9, 10, 13, 15, 20, 23) based on a base configuration file table of a new home page.

2. The system as claimed in claim 1, wherein various Internet address names containing a phone number or the like are formalized by applying a rule to the created multi-dimensional bidirectional websites (9, 10, 11, 13, 15, 20, 23), and the website can be searched through the internet address bar within any type web browser

3. The system as claimed in claim 1, wherein a website corresponding to desired contents, region, or business type is automatically displayed on the mobile telecommunication terminal (22) of a customer in response to a request of the customer and thus can be inputted and updated, in the websites (2, 14, 26) and the multi-relational multi-dimensional bidirectional websites (9, 11, 10, 13, 15, 20, 23) using multi-Internet addresses.

4. The system as claimed in claim 2, wherein in a case where a user's request for multi-dimensional sharing is received through a website registered in the database (4) or a personal website, if the Internet server (6) transmits a joining request data to a computer (14) or a mobile telecommunication terminal (29) of a manager of each enterprise or personal site or a decision maker who determines acceptance of the joining request, through a mobile telecommunication company system (24) and mobile telecommunication base station (21), the decision maker searches for a desired relation criterion from the database (4) of the Internet server (6) and transmits characters or Internet data for permitting the request of adding a relation, and the Internet server (6) transmits the permission data to the mobile telecommunication terminal (27) of the new member (3) and notifies the permission data to the manager of each multi-relational multi-dimensional specialty Internet contents company (9, 11, 10, 13, 15, 20, 23) through the Internet server (6).

5. The system as claimed in claim 1, wherein the Internet server (6) can construct websites for all individuals, a multi-dimensional personal website (11) hierarchically related to companies, and a network relation type multi-dimensional community site where the personal sites are associated with one another, independently using information such as a phone number as an Internet address.

6. The system as claimed in claim 1, wherein the Internet server (6) includes a plurality of databases (4), independently creates a plurality of personal websites for a plurality of individuals using personal information such as a phone number as an Internet address through a hierarchy relational multi-dimensional Internet data bidirectional management website system, constructs a multi-relational multi-dimensional website of immovables such as, houses, buildings, towns, and the like, and movables, such as vehicles, buses, computers, and the like, by multiply relating the created personal or company websites, and creating a remotely managed website for providing multiple channels using different names as Internet addresses.

7. The system as claimed in claim 1, wherein each of websites (2, 14, 26) that use different Internet addresses is provided with a database that stores relation points between a web company (12) and related other companies or customers or results of using websites (9, 11, 10, 13, 15, 20, 23) for which different customers use different Internet addresses, records transaction relations, the number of connections, or usage of a customer in each website, allows companies or individuals having a point larger than a certain point to receive an advertisement fee from a company (9) that desires a relation of sharing new contents, and transmits the points of a company or individual and usage result of a user to each of the mobile telecommunication terminals (29, 22), and the Internet server (6) that is configured to transmit characters or graphic data to the mobile telecommunication terminal (22) through the mobile telecommunication company' system (24) transmits a coupon of a character or graphic form to the mobile telecommunication terminal (22) of the customer depending on the usage result of the customer so that the customer can use the coupon when the customer uses a multi-dimensional website (10) using a different Internet address.
